(19) United States
(12) Patent Application Publication
(10) Pub. No.: US 2009/0115732 A1
(43) Pub. Date: May 7, 2009

(54) Keyboard structure with a keyboard input function and a sensor pad input function

(76) Inventors: Yi-Wei Tao, Hsichih (TW); Ming-Jen Huang, Hsichih (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,185

(22) Filed: Mar. 3, 2008

(30) Foreign Application Priority Data
Nov. 2, 2007 (TW) 96141506

(51) Int. Cl. G06F 3/02

(52) U.S. Cl. 345/168; 345/173

(57) ABSTRACT

A keyboard structure with a keyboard input function and a sensor pad input function includes a motherboard module, a keyboard module, and a sensor pad module. The keyboard module is electrically connected with the motherboard module, and the keyboard module has a keyboard/sensor pad input function switch unit. The sensor pad module is electrically connected with the motherboard module, and the sensor pad module has a sensor unit disposed under the keyboard module. Therefore, the keyboard/sensor pad input function switch unit is switched in order to selectively use the sensor pad input function of the sensor pad module or the keyboard input function of the keyboard module.

### BACKGROUND OF THE INVENTION

1. Field of the Invention

The present invention relates to a keyboard structure, and particularly relates to a keyboard structure with a keyboard input function and a sensor pad input function.

2. Description of the Related Art

According to the development of technology and market requirements, many light keyboards are designed out and has been applied to portable computers (or portable information processing products) in order to reduce the size of the portable computers.

FIG. 1 shows a perspective, schematic view of a touch pad and a keyboard integrated with each other according to the prior art. The prior art provides a keyboard structure 1 that has a keyboard 11 and a touch pad 10 integrated on the keyboard 11, so that the keyboard structure has both a keyboard input function and a sensor pad input function. In other words, the keyboard 11 has some partial area spared for receiving the touch pad 10 in order to be used instead of a mouse. However, the prior art not only cannot reduce the size of the keyboard structure 1, but also cannot applied to portable computers.

### SUMMARY OF THE INVENTION

One particular aspect of the present invention is to provide a keyboard structure with a keyboard input function and a sensor pad input function. The keyboard structure has a sensor pad disposed under key bodies, and the sensor pad replaces a touch pad of the prior art. Moreover, the keyboard structure of the present invention can be selectively switched by a user to use the keyboard input function or the sensor pad input function.

In other words, one or more capacitive sensor pad modules are disposed under the keyboard module (the capacitive sensor pad modules and the keyboard module overlap each other). In addition, the keyboard module does not need to spare an area for receiving the capacitive sensor pad modules, so that the size of the keyboard structure can be reduced and the keyboard structure can be applied to smaller portable electronic devices. Furthermore, the keyboard structure has a keyboard/sensor pad input function switch unit that can be selectively switched by a user to use the keyboard input function or the sensor pad input function.

In order to achieve the above-mentioned aspects, the present invention provides a keyboard structure with a keyboard input function and a sensor pad input function, including: a motherboard module, a keyboard module, and a sensor pad module. The keyboard module is electrically connected with the motherboard module, and the keyboard module has a keyboard/sensor pad input function switch unit. The sensor pad module is electrically connected with the motherboard module, and the sensor pad module has a sensor unit disposed under the keyboard module. Therefore, the keyboard/sensor pad input function switch unit is switched in order to selectively use the sensor pad input function of the sensor pad module or the keyboard input function of the keyboard module.

In order to achieve the above-mentioned aspects, the present invention provides a keyboard structure with a keyboard input function and a sensor pad input function, including: a motherboard module, a keyboard/sensor pad input function switch unit, a keyboard module, and a sensor pad module. The keyboard/sensor pad input function switch unit is connected with the motherboard module, and the keyboard/sensor pad input function switch unit has a keyboard function selected item and a sensor pad function selected item. The keyboard module is connected with the motherboard module. The sensor pad module is electrically connected with the motherboard module, and the sensor pad module has a sensor unit disposed under the keyboard module. Therefore, the keyboard/sensor pad input function switch unit is switched to the keyboard function selected item or the sensor pad function selected item in order to selectively use the sensor pad input function of the sensor pad module or the keyboard input function of the keyboard module.

In order to achieve the above-mentioned aspects, the present invention provides a keyboard structure with a keyboard input function and a sensor pad input function, including: a motherboard module, a control IC, a keyboard/sensor pad input function switch unit, a keyboard module, and a sensor pad module. The keyboard/sensor pad input function switch unit is connected with the control IC, and the keyboard/sensor pad input function switch unit has a keyboard function selected item and a sensor pad function selected item. The keyboard module is connected with the motherboard module and the control IC. The sensor pad module is electrically connected with the motherboard module and the control IC, and the sensor pad module has a sensor unit disposed under the keyboard module. Therefore, the keyboard/sensor pad input function switch unit is switched to the keyboard function selected item or the sensor pad function selected item in order to selectively use the sensor pad input function of the sensor pad module or the keyboard input function of the keyboard module.

Hence, the keyboard structure of the present invention has some advantages, as follow:

1. Because the capacitive sensor pad modules are disposed under the keyboard module, the size of the keyboard structure can be reduced.

2. The user can use the sensor pad input function without touching the keyboard module due to the usage of the capacitive sensor pad modules.

3. It is convenient for the user to selectively use the keyboard input function or the sensor pad input function.

4. When the user holds the keyboard module by both hands, the user still can operate the keyboard structure.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a perspective, schematic view of a touch pad and a keyboard integrated with each other according to the prior art;

FIG. 2A is a perspective, schematic view of a keyboard structure with a keyboard input function and a sensor pad input function applied to a portable electronic device according to the present invention;

FIG. 2B is a cross-sectional view along line B-B in FIG. 2A;

FIG. 2C is a perspective, schematic view showing a usage state of a keyboard structure with a keyboard input function and a sensor pad input function applied to a portable electronic device according to the present invention;

FIG. 3 is a function diagram of a keyboard structure with a keyboard input function and a sensor pad input function applied to a portable electronic device according to the first embodiment of the present invention;

FIG. 4 is a function diagram of a keyboard structure with a keyboard input function and a sensor pad input function applied to a portable electronic device according to the second embodiment of the present invention;

FIG. 5 is a function diagram of a keyboard structure with a keyboard input function and a sensor pad input function applied to a portable electronic device according to the third embodiment of the present invention; and

FIG. 6 is a function diagram of a keyboard structure with a keyboard input function and a sensor pad input function applied to a portable electronic device according to the fourth embodiment of the present invention.

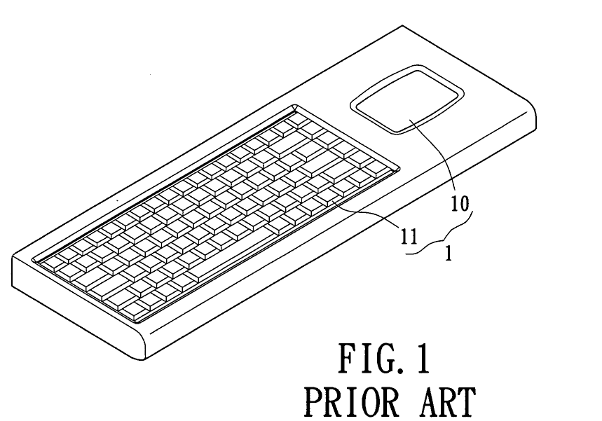

### DETAILED DESCRIPTION OF THE PREFERRED EMBODIMENTS

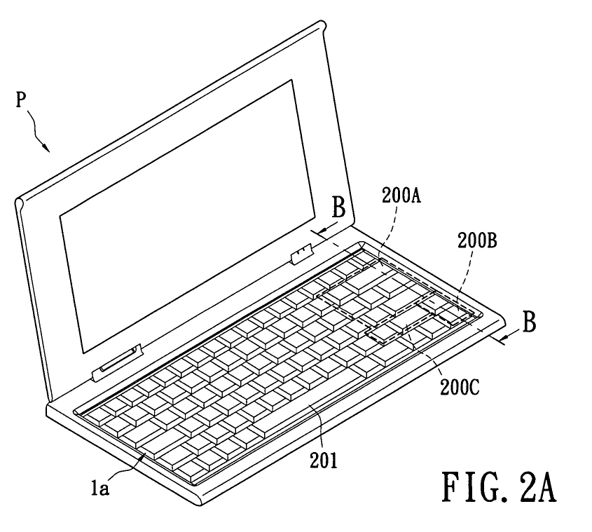

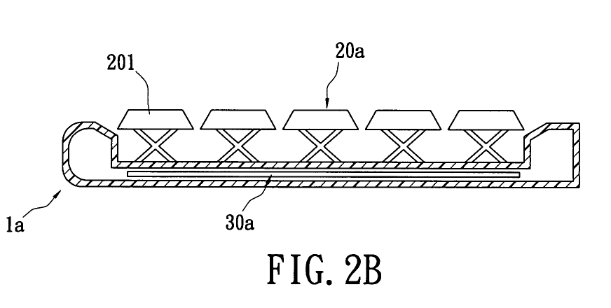

Referring to FIGS. 2A to 3, FIG. 2A shows a perspective, schematic view of a keyboard structure with a keyboard input function and a sensor pad input function applied to a portable electronic device according to the present invention, FIG. 2B shows a cross-sectional view along line B-B in FIG. 2A, FIG. 2C shows a perspective, schematic view showing a usage state of a keyboard structure with a keyboard input function and a sensor pad input function applied to a portable electronic device according to the present invention, and FIG. 3 shows a function diagram of a keyboard structure with a keyboard input function and a sensor pad input function applied to a portable electronic device according to the first embodiment of the present invention.

The first embodiment of the present invention provides a keyboard structure 1a with a keyboard input function and a sensor pad input function. The keyboard structure 1a includes a motherboard module 10a, a keyboard module 20a and a sensor pad module 30a. In addition, the keyboard structure 1a is applied to a portable electronic device P that has an image display module 40 electrically connected with the motherboard module 10a.

The motherboard module 10a has a control IC (Integrated Circuit) 100a electrically connected with the keyboard module 20a and the sensor pad module 30a in order to selectively turn on the keyboard input function of the keyboard module 20a and turn off the sensor pad input function of the sensor pad module 30a, or to turn off the keyboard input function of the keyboard module 20a and turn on the sensor pad input function of the sensor pad module 30a.

Moreover, the keyboard module 20a is electrically connected with the motherboard module 10a, and the keyboard module 20a has a keyboard/sensor pad input function switch unit 200a that is connected with the control IC 100a of the motherboard module 10a. In addition, the keyboard module 20a has a plurality of key bodies 201, and the keyboard/sensor pad input function switch unit 200a is one of the key bodies 201.

Furthermore, the sensor pad module 30a is electrically connected with the motherboard module 10a, and the sensor pad module 30a has a sensor unit 300a disposed under the keyboard module 20a. The sensor unit 300a can be a non-contact sensor unit such as a non-contact capacitive sensor array. Because the electric field of the non-contact capacitive sensor array is destroyed by static electricity from a user's body, the non-contact capacitive sensor array can judge where the position of the finger of the user is. Hence, the sensor pad module 30a can be a capacitive sensor pad module whose function similar to a touch pad and same to a non-contact sensor pad. In other words, charge transfer can be used to move the cursor according to charge conservation principle. It means that the sensor pad module 30a can sense the finger of the user when the finger is close to the sensor pad module 30a. Therefore, the capacitive sensor pad module is applied to the present invention in order to achieve non-contact sensor function.

Moreover, the sensor unit 300a is disposed under one part of the key bodies 201. The part of the key bodies 201 disposed over the sensor unit 300a is divided into a track pad area 200A, an up/down scroll area 200B and a left/right mouse click area 200C.

The track pad area 200A is used to move a cursor on a display of a computer such as using traditional mouse to drive the cursor to move on the display. The up/down scroll area 200B is used to roll page on the display such as using a wheel of a middle click of the traditional mouse. The left/right mouse click area 200C is such as a left click and a right click of the traditional mouse.

Therefore, when a user presses (switches) the keyboard/sensor pad input function switch unit 200a once, a finger of the user can lightly touch on the keyboard module 20a disposed over the sensor unit 300a or can be slightly separated from the keyboard module 20a disposed over the sensor unit 300a by a predetermined distance in order to using the sensor pad input function of the sensor pad module 30a to replace the keyboard input function of the keyboard module 20a (the keyboard input function of the keyboard module 20a is stopped at the same time). Moreover, when the user presses (switches) the keyboard/sensor pad input function switch unit 200a again, the user can use the keyboard input function of the keyboard module 20a (the sensor pad input function of the sensor pad module 30a is stopped at the same time). However, the action of press does not used to limit the present invention. For example, when the user continuously presses and holds the keyboard/sensor pad input function switch unit 200a, the user can use the sensor pad input function of the sensor pad module 30a; when the user releases the keyboard/sensor pad input function switch unit 200a, the user can use the keyboard input function of the keyboard module 20a.

In other words, referring to FIGS. 2C and 3, when the user holds the portable electronic device P by both hands, the user using the sensor pad input function of the keyboard structure 1 a needs to follow some steps, as follows:

1. The user presses the keyboard/sensor pad input function switch unit 200a once by a left thumb LT, and a switch massage is transmitted from the keyboard/sensor pad input function switch unit 200a to the control IC 100a of the motherboard module 10a;

2. The control IC 100a respectively transmits a turn on command and a turn off command to the sensor pad module 30a and the keyboard module 20a, in order to turn on the sensor pad input function of the sensor pad module 30a and turn off the keyboard input function of the keyboard module 20a;

3. The user uses a right thumb RT to lightly touch the key bodies 201 disposed over the sensor unit 300a and slidably move on the top surfaces (on the track pad area 200A, the up/down scroll area 200B and the left/right mouse click area 200C) of the key bodies 201;

4. Above-mentioned actions of slidably moving are transmitted to the motherboard module 10a via the sensor pad module 30a and transformed into an operation command; and

5. The operation command is shown on the image display module 40 to display the actions of slidably moving on the track pad area 200A, the up/down scroll area 200B and the left/right mouse click area 200C by the right thumb RT.

Furthermore, when the user holds the portable electronic device P by both hands, the user using the keyboard input function of the keyboard structure 1a needs to follow some steps, as follows:

1. The user presses the keyboard/sensor pad input function switch unit 200a once by the left thumb LT, and a switch massage is transmitted from the keyboard/sensor pad input function switch unit 200a to the control IC 100a of the motherboard module 10a;

2. The control IC 100a respectively transmits a turn on command and a turn off command to the keyboard module 20a and the sensor pad module 30a, in order to turn on the keyboard input function of the keyboard module 20a and turn off the sensor pad input function of the sensor pad module 30a;

3. The user can stoke the key bodies 201 to key-in data;

4. Above-mentioned data keyed-in by the user are transmitted to the motherboard module 10a via the keyboard module 20a and transformed into an operation command; and

5. The operation command is shown on the image display module 40 to display the data keyed-in by the user.

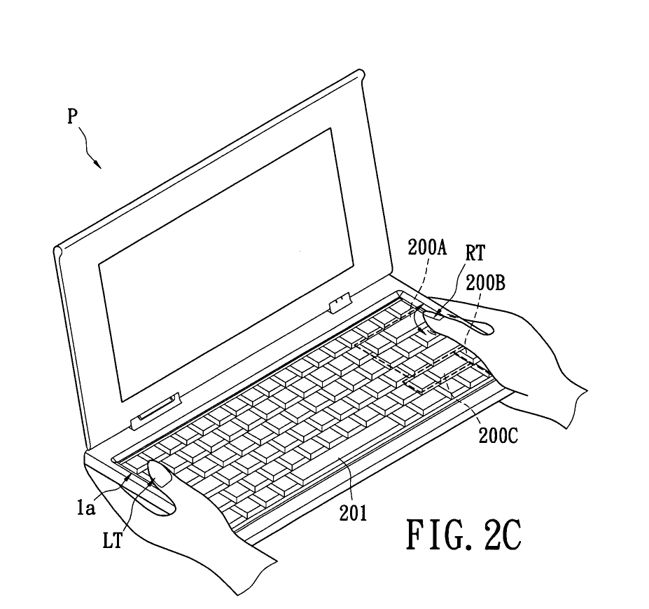

FIG. 4 shows a function diagram of a keyboard structure with a keyboard input function and a sensor pad input function applied to a portable electronic device according to the second embodiment of the present invention. The difference between the second embodiment and the first embodiment is that: in the second embodiment, a keyboard structure 1b includes a control IC 100b that is an independent control chip and is electrically connected with a keyboard module 20b and a sensor pad module 30b in order to selectively turn on the keyboard input function of the keyboard module 20b and turn off the sensor pad input function of the sensor pad module 30b, or to turn off the keyboard input function of the keyboard module 20b and turn on the sensor pad input function of the sensor pad module 30b. In addition, the keyboard module 20b is electrically connected with a motherboard module 10b and has a keyboard/sensor pad input function switch unit 200b connected with the control IC 100b. The sensor pad module 30b is electrically connected with the motherboard module 10b and has a sensor unit 300b disposed under the keyboard module 20b.

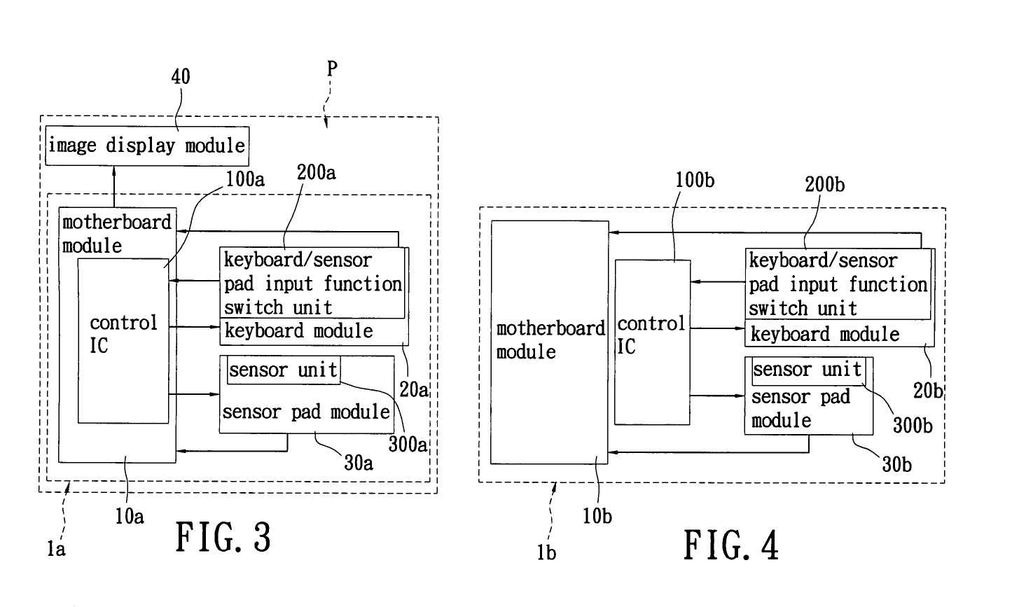

FIG. 5 shows a function diagram of a keyboard structure with a keyboard input function and a sensor pad input function applied to a portable electronic device according to the third embodiment of the present invention. The difference between the third embodiment and the first embodiment is that: in the third embodiment, a keyboard structure 1c includes a keyboard/sensor pad input function switch unit 200c that is an independent function switch. The keyboard/sensor pad input function switch unit 200c is connected with a control IC 100c of a motherboard module 10c. The keyboard/sensor pad input function switch unit 200c has a keyboard function selected item K and a sensor pad function selected item T.

Therefore, when the user switches the keyboard/sensor pad input function switch unit 200c to the sensor pad function selected item T, the finger of the user can lightly touch on a keyboard module 20c disposed over a sensor unit 300c or can be slightly separated from the keyboard module 20c disposed over the sensor unit 300c by a predetermined distance in order to using the sensor pad input function of a sensor pad module 30c to replace the keyboard input function of the keyboard module 20c (the keyboard input function of the keyboard module 20c is stopped at the same time). Moreover, when the user switches the keyboard/sensor pad input function switch unit 200c to the keyboard function selected item K, the user can use the keyboard input function of the keyboard module 20c (the sensor pad input function of the sensor pad module 30c is stopped at the same time).

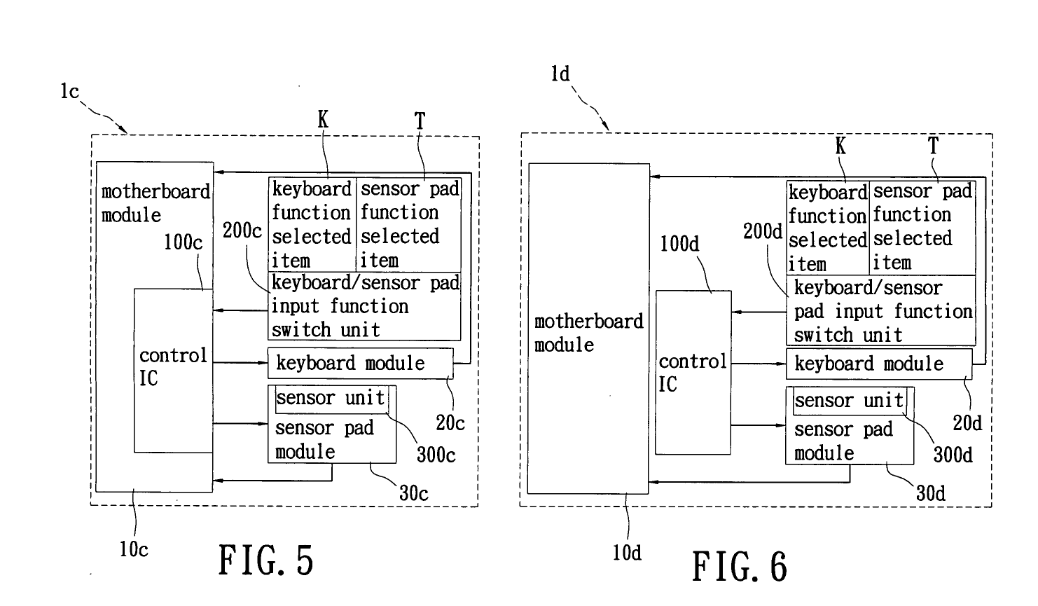

FIG. 6 shows a function diagram of a keyboard structure with a keyboard input function and a sensor pad input function applied to a portable electronic device according to the fourth embodiment of the present invention. The difference between the fourth embodiment and the third embodiment is that: in the fourth embodiment, a keyboard structure Id includes a control IC 100d that is an independent control chip and is electrically connected with a keyboard module 20d and a sensor pad module 30d in order to selectively turn on the keyboard input function of the keyboard module 20d and turn off the sensor pad input function of the sensor pad module 30d, or to turn off the keyboard input function of the keyboard module 20d and turn on the sensor pad input function of the sensor pad module 30d. In addition, a keyboard/sensor pad input function switch unit 200d has a keyboard function selected item K and a sensor pad function selected item T. The sensor pad module 30d has a sensor unit 300d disposed under the keyboard module 20d.

In conclusion, the present invention provides one or more capacitive sensor pad modules that are disposed under the keyboard module (the capacitive sensor pad modules and the keyboard module overlap each other). In addition, the keyboard module does not need to spare an area for receiving the capacitive sensor pad modules, so that the size of the keyboard structure can be reduced and the keyboard structure can be applied to smaller portable electronic devices. Furthermore, the keyboard structure has a keyboard/sensor pad input function switch unit that can be selectively switched by a user to use the keyboard input function or the sensor pad input function.

Hence, the keyboard structure of the present invention has some advantages, as follow:

1. Because the capacitive sensor pad modules are disposed under the keyboard module, the size of the keyboard structure can be reduced.

2. The user can use the sensor pad input function without touching the keyboard module due to the usage of the capacitive sensor pad modules.

3. It is convenient for the user to selectively use the keyboard input function or the sensor pad input function.

4. When the user holds the keyboard module by both hands, the user still can operate the keyboard structure.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A keyboard structure with a keyboard input function and a sensor pad input function, comprising:
a motherboard module;
a keyboard module electrically connected with the motherboard module, wherein the keyboard module has a keyboard/sensor pad input function switch unit; and
a sensor pad module electrically connected with the motherboard module, wherein the sensor pad module has a sensor unit disposed under the keyboard module;
whereby, the keyboard/sensor pad input function switch unit is switched in order to selectively use the sensor pad input function of the sensor pad module or the keyboard input function of the keyboard module.

2. The keyboard structure as claimed in claim 1, wherein the motherboard module has a control IC (Integrated Circuit) electrically connected with the keyboard module and the sensor pad module in order to selectively turn on the keyboard input function of the keyboard module and turn off the sensor pad input function of the sensor pad module, or to turn off the keyboard input function of the keyboard module and turn on the sensor pad input function of the sensor pad module.

3. The keyboard structure as claimed in claim 1, further comprising a control IC electrically connected with the keyboard module and the sensor pad module in order to selectively turn on the keyboard input function of the keyboard module and turn off the sensor pad input function of the sensor pad module, or to turn off the keyboard input function of the keyboard module and turn on the sensor pad input function of the sensor pad module.

4. The keyboard structure as claimed in claim 1, wherein the keyboard module has a plurality of key bodies, and the sensor unit is disposed under one part of the key bodies.

5. The keyboard structure as claimed in claim 4, wherein the part of the key bodies disposed over the sensor unit is divided into a track pad area, an up/down scroll area and a left/right mouse click area.

6. The keyboard structure as claimed in claim 4, wherein the keyboard/sensor pad input function switch unit is one of the key bodies.

7. The keyboard structure as claimed in claim 1, wherein the sensor unit is a non-contact capacitive sensor array.

8. A keyboard structure with a keyboard input function and a sensor pad input function, comprising:
a motherboard module;
a keyboard/sensor pad input function switch unit connected with the motherboard module, wherein the keyboard/sensor pad input function switch unit has a keyboard function selected item and a sensor pad function selected item;
a keyboard module connected with the motherboard module; and
a sensor pad module electrically connected with the motherboard module, wherein the sensor pad module has a sensor unit disposed under the keyboard module;
whereby, the keyboard/sensor pad input function switch unit is switched to the keyboard function selected item or the sensor pad function selected item in order to selectively use the sensor pad input function of the sensor pad module or the keyboard input function of the keyboard module.

9. The keyboard structure as claimed in claim 8, wherein the motherboard module has a control IC (Integrated Circuit) electrically connected with the keyboard module and the sensor pad module in order to selectively turn on the keyboard input function of the keyboard module and turn off the sensor pad input function of the sensor pad module, or to turn off the keyboard input function of the keyboard module and turn on the sensor pad input function of the sensor pad module.

10. The keyboard structure as claimed in claim 8, wherein the keyboard module has a plurality of key bodies, and the sensor unit is disposed under one part of the key bodies.

11. The keyboard structure as claimed in claim 10, wherein the part of the key bodies disposed over the sensor unit is divided into a track pad area, an up/down scroll area and a left/right mouse click area.

12. The keyboard structure as claimed in claim 8, wherein the sensor unit is a non-contact capacitive sensor array.

13. A keyboard structure with a keyboard input function and a sensor pad input function, comprising:
a motherboard module;
a control IC;
a keyboard/sensor pad input function switch unit connected with the control IC, wherein the keyboard/sensor pad input function switch unit has a keyboard function selected item and a sensor pad function selected item;
a keyboard module connected with the motherboard module and the control IC; and
a sensor pad module electrically connected with the motherboard module and the control IC, wherein the sensor pad module has a sensor unit disposed under the keyboard module;
whereby, the keyboard/sensor pad input function switch unit is switched to the keyboard function selected item or the sensor pad function selected item in order to selectively use the sensor pad input function of the sensor pad module or the keyboard input function of the keyboard module.
